(19) United States
(12) Patent Application Publication
(10) Pub. No.: US 2026/0268671 A1
(43) Pub. Date: Sep. 10, 2026

(54) APPARATUS FOR PROCESSING CONTENT AND METHOD THEREOF

(71) Applicants: HYUNDAI MOTOR COMPANY, SEOUL (KR); KIA CORPORATION, SEOUL (KR)

(72) Inventor: Sung Woo Moon, Hwaseong-si (KR)

(73) Assignees: HYUNDAI MOTOR COMPANY, SEOUL (KR); KIA CORPORATION, SEOUL (KR)

(21) Appl. No.: 19/288,513

(22) Filed: Aug. 1, 2025

(30) Foreign Application Priority Data
Mar. 10, 2025 (KR) 10-2025-0030890

(51) Int. Cl. G06V 20/40; G06F 40/40; G06V 20/56

(52) U.S. Cl. CPC G06V 20/47; G06F 40/40; G06V 20/49; G06V 20/56

(57) ABSTRACT

A content processing apparatus includes a memory that stores computer-executable instructions, and a processor that executes the instructions by accessing the memory. The processor obtains target information of an image frame by applying the image frame to a first generation model trained to process an image based on a large language model (LLM). Based on the analysis, the processor obtains at least one recommended sentence regarding generating content related to the image frame by applying the target information to a second generation model for sentence generation. Then, based on the previous analysis, the processor obtains recommendation information of content by applying a target sentence among the at least one recommended sentence to a third generation model trained to recommend the content based on the LLM, and provides the recommendation information based on a response of a user for identifying the content.

### CROSS REFERENCE TO RELATED APPLICATIONS

This application claims the benefit of priority to Korean Patent Application No. 10-2025-0030890, filed in the Korean Intellectual Property Office on Mar. 10, 2025, the entire contents of which are incorporated herein by reference.

### TECHNICAL FIELD

The present disclosure relates to a content processing apparatus and a method thereof, and more particularly, relates to a technology for providing a user with recommendation information about content from an image frame.

### BACKGROUND

A song recommendation system typically recommends songs of similar genres or artists based on a user's listening history. However, because this method does not take into account the user's current situation (e.g., weather, location, mood, or the like), there is a limitation in automatically recommending appropriate music at a specific moment. For example, if the user is exercising or driving outdoors, existing systems simply make recommendations based on past listening history, and thus, they are likely to recommend songs that do not match current environmental factors.

Moreover, some previous studies proposed techniques to recommend songs by using image information, but these systems still include the limitation of requiring text input. In other words, because appropriate recommendations are made only if the user enters emotions or situations by using text, full automation is difficult to implement. This may cause discomfort, especially in situations where the user is driving, or the user's hand is not free.

To solve these issues, there is a need to develop a system capable of automatically recognizing a current environment without separate input from the user and recommending music suitable for the recognized result, and a technology capable of providing a more intuitive and convenient music listening experience by analyzing images or sensor data to identify the user's current state and providing music suitable for the analyzed result.

### SUMMARY

The present disclosure was made to solve the above-mentioned problems occurring in the prior art while advantages achieved by the prior art are maintained intact.

An aspect of the present disclosure provides a content processing apparatus capable of providing appropriate music to a user even though he/she is driving or his/her hand is not free by analyzing the user's environment in real time in conjunction with a black box camera, a smartphone camera, and other image sensors, and providing a more intuitive and convenient music recommendation experience, and a method thereof.

An aspect of the present disclosure provides a content processing apparatus capable of automatically selecting music suitable for driving environments (e.g., night driving, rainy days, highway driving, etc.) by analyzing a black box video, and a method thereof.

An aspect of the present disclosure provides a content processing apparatus capable of providing various songs by training the user's music listening pattern such that the same music is not recommended every time, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a content processing apparatus includes a memory that stores a computer-executable instruction, and a processor that executes the instruction by accessing the memory. The processor obtains target information of an image frame by applying the image frame to a first generation model trained to process an image based on a large language model (LLM), obtains at least one recommended sentence regarding generating content related to the image frame by applying the target information to a second generation model for sentence generation, obtains recommendation information of content by applying a target sentence among the at least one recommended sentence to a third generation model trained to recommend the content based on the LLM, and provides the recommendation information based on a response of a user for identifying the content.

In an embodiment, the processor may identify video data from an image processor included in a vehicle, or a terminal of the user, may obtain the image frame by splitting the video data based on a predetermined time, and may obtain the target information by applying a frame subsequent to the image frame in the video data to the first generation model if failing to obtain the target information by applying the image frame to the first generation model.

In an embodiment, the processor may receive the target information from an external server if failing to obtain the target information from the first generation model during a predetermined time interval.

In an embodiment, the first generation model may include an LLM trained with few-shot learning. The second generation model may include a natural language processing model. The third generation model may include an LLM trained to recommend content based on the user's existing content list. The target information may include one or more keywords or a combination of multiple keywords from a first keyword regarding a location where the image frame is captured, a second keyword regarding the weather of the location and a time point at which the image frame is captured, or a third keyword regarding a mood of the image frame.

In an embodiment, the processor may obtain the at least one recommended sentence, including the first keyword, the second keyword, and the third keyword, by applying the first keyword, the second keyword, and the third keyword to the second generation model.

In an embodiment, the processor may sort the at least one recommended sentence depending on a first priority, based on the predetermined first priority, may sort the sorted at least one recommended sentence depending on a second priority if the predetermined second priority of the user is identified, and may determine a sentence with the highest priority among the sorted at least one recommended sentence as the target sentence.

In an embodiment, the processor may identify at least one song title from the recommendation information if the content is a song, may receive a response from the user by providing the user with the at least one song title, and may play a song regarding one song title among the at least one song title based on the response of the user.

In an embodiment, the processor may update the second priority based on the response of the user.

According to an aspect of the present disclosure, a content processing method includes obtaining target information of an image frame by applying the image frame to a first generation model trained to process an image based on an LLM, obtaining at least one recommended sentence regarding generating content related to the image frame by applying the target information to a second generation model for sentence generation, obtaining recommendation information of content by applying a target sentence among the at least one recommended sentence to a third generation model trained to recommend the content based on the LLM, and providing the recommendation information based on a response of a user for identifying the content.

In an embodiment, the providing of the recommendation information may include identifying video data from an image processor included in a vehicle, or a terminal of the user, obtaining the image frame by splitting the video data based on a predetermined time, and obtaining the target information by applying a frame subsequent to the image frame in the video data to the first generation model if failing to obtain the target information by applying the image frame to the first generation model.

In an embodiment, providing the recommendation information may include receiving the target information from an external server if failing to obtain the target information from the first generation model during a predetermined time interval.

In an embodiment, providing the recommendation information may include obtaining the at least one recommended sentence, including the first keyword, the second keyword, and the third keyword by applying the first keyword, the second keyword, and the third keyword to the second generation model.

In an embodiment, providing the recommendation information may include sorting the at least one recommended sentence depending on a first priority, based on the predetermined first priority, sorting the sorted at least one recommended sentence depending on a second priority if the predetermined second priority of the user is identified, and determining a sentence with the highest priority among the sorted at least one recommended sentence as the target sentence.

In an embodiment, providing the recommendation information may include identifying at least one song title from the recommendation information if the content is a song, receiving a response from the user by providing the user with at least one song title, and playing a song regarding one song title among the at least one song title based on the response of the user.

In an embodiment, providing the recommendation information may include updating the second priority based on the response of the user.

### BRIEF DESCRIPTION OF THE FIGURES

The above and other objects, features and advantages of the present disclosure will be more apparent from the following detailed description taken in conjunction with the accompanying drawings:

FIG. 1 is a drawing illustrating a content processing apparatus according to an embodiment of the present disclosure;

FIG. 2 is a flowchart for describing a content processing method according to an embodiment of the present disclosure;

FIG. 3 is a diagram illustrating a method for obtaining target information through a first generation model in a content processing apparatus, according to an embodiment of the present disclosure;

FIG. 4 is a drawing illustrating an example of an interface for outputting target information in a content processing apparatus, according to an embodiment of the present disclosure;

FIG. 5 is a diagram illustrating an example of an interface for outputting recommendation information of content in a content processing apparatus, according to an embodiment of the present disclosure;

FIG. 6 is a flowchart for describing a content processing method in a content processing apparatus, according to an embodiment of the present disclosure; and

FIG. 7 is a diagram illustrating a computing system related to a content processing apparatus or a content processing method, according to an embodiment of the present disclosure.

With regard to the description of drawings, the same or similar components will be marked by the same or similar reference signs.

### DETAILED DESCRIPTION

Hereinafter, some embodiments of the present disclosure will be described in detail with reference to the accompanying drawings. When adding reference numerals to components of each drawing, it should be noted that the same components include the same reference numerals, although they are indicated on another drawing. Furthermore, in describing the embodiments of the present disclosure, detailed descriptions associated with well-known functions or configurations will be omitted if they may make subject matters of the present disclosure unnecessarily obscure. Hereinafter, various embodiments of the present disclosure may be described with reference to the accompanying drawings. Accordingly, those of ordinary skill in the art will recognize that modification, equivalent, and/or alternative to the various embodiments described herein may be variously made without departing from the scope and spirit of the present disclosure. With regard to the description of drawings, similar components may be marked by similar reference numerals.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the technical field to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein. For example, the terms such as “first,” “second,” and the like used herein may refer to various elements of various embodiments of the present disclosure but do not limit the elements. For example, “a first user device” and “a second user device” may indicate different user devices regardless of the order or priority thereof. For example, without departing the scope of the present disclosure, a first complement may be referred to as a second component, and similarly, a second complement may be referred to as a first complement.

In this specification, the expressions “possess,” “may possess,” “include,” and “comprise,” or “may include” and “may comprise” used herein indicate the existence of corresponding features (e.g., elements such as numeric values, functions, operations, or components) but do not exclude the presence of additional features.

When a controller, component, device, element, part, unit, module, or the like of the present disclosure is described as having a purpose or performing an operating, function, or the like, the controller, component, device, element, part, unit, or module should be considered herein as being “configured to” meet that purpose or perform that operating or function. Each controller, component, device, element, part, unit, module, and the like may separately embody or be included with a processor and a memory, such as a non-transitory computer-readable media, as part of the apparatus.

It will be understood that if an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, if an element (e.g., a first element) is referred to as being “directly coupled with/to” or “directly connected to” another element (e.g., a second element), it should be understood that there is no intervening element (e.g., a third element).

According to the situation, the expression “configured to” used herein may be used as, for example, the expression “suitable for,” “including the capacity to,” “designed to,” “adapted to,” “made to,” or “capable of.”

The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device. The terms used in the specification are only used to describe a specific embodiment and are not intended to limit the scope of the present disclosure. The terms of a singular form may include plural forms unless otherwise specified. All the terms used herein, which include technical or scientific terms, may include the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even though terms are terms that are defined in the specification, they may not be interpreted to exclude embodiments of the present disclosure.

In the present disclosure disclosed herein, the expressions “A or B,” “at least one of A or/and B,” or “one or more of A or/and B,” and the like used herein may include any and all combinations of one or more of the associated listed items. For example, the terms “A or B,” “at least one of A and B,” or “at least one of A or B” may refer to all of the case (1) where at least one A is included, the case (2) where at least one B is included, or the case (3) where both of at least one A and at least one B are included. Moreover, in describing a component of an embodiment of the present disclosure, the expressions at least one of “A or B,” “at least one of A and B,” “at least one of A or B,” “A, B, or C,” “at least one of A, B, and C,” or “at least one of A, B, or C, or any combination thereof” may include any and all combinations of one or more of the associated listed items. In particular, expressions “at least one of A, B, or C, or any combination thereof” may include A, B, or C, or any combination thereof such as AB, ABC, or the like.

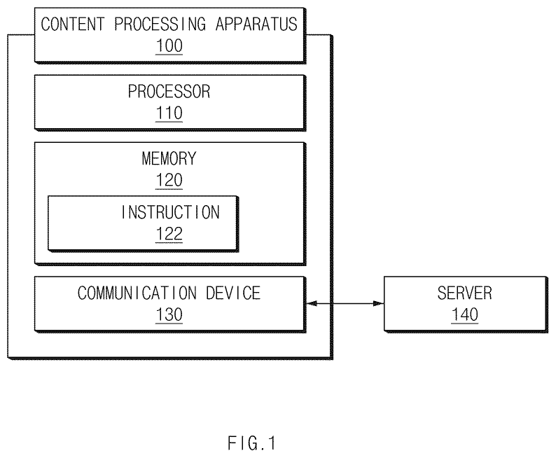

Hereinafter, embodiments of the present disclosure will be described in detail with reference to FIGS. 1 to 7.

FIG. 1 is a drawing illustrating a content processing apparatus according to an embodiment of the present disclosure.

A content processing apparatus 100, according to an embodiment, may include a processor 110, a memory 120 including instructions 122, and a communication device 130.

The content processing apparatus 100 may represent a device that provides recommendation information of content to a user. For example, the content processing apparatus 100 may obtain target information of an image frame from an image frame. The content processing apparatus 100 may obtain recommended sentences regarding the generation of content (e.g., songs or videos) related to the image frame based on the target information. The content processing apparatus 100 may obtain recommendation information of content based on the recommended sentences.

The processor 110 may execute software and may control at least one other component (e.g., a hardware or software component) connected to the processor 110. The processor 110 may also perform various data processing or operations. For example, the processor 110 may store a generation model, or an image frame, or the like in the memory 120.

For reference, the processor 110 may perform all operations performed by the content processing apparatus 100. Therefore, for convenience of description in this specification, an operation performed by the content processing apparatus 100 is mainly described as an operation performed by the processor 110.

Furthermore, for convenience of description in this specification, the processor 110 is mainly described as a single processor, but is not limited thereto. For example, the content processing apparatus 100 may include processors. Each of the processors may perform all operations related to providing the recommendation information.

The memory 120 may temporarily and/or permanently store various pieces of data and/or information required to perform an operation of providing the recommendation information. For example, the memory 120 may store a generation model, an image frame, or the like.

The communication device 130 may support communication between the content processing apparatus 100 and a server 140. For example, the communication device 130 may include one or more components for communicating between the content processing apparatus 100 and the server 140. For example, the communication device 130 may include a short-range wireless communication device, a microphone, or the like. In this case, short-range communication technologies include wireless LAN (Wi-Fi), Bluetooth, ZigBee, Wi-Fi Direct (WFD), ultra-wideband (UWB), infrared data association (IrDA), Bluetooth Low Energy (BLE), and near field communication (NFC), and the like, but are not limited thereto.

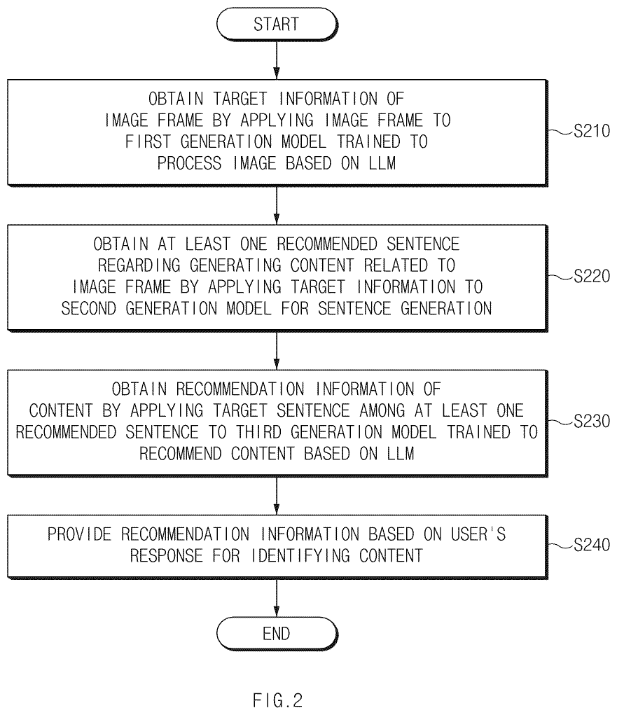

FIG. 2 is a flowchart for describing a content processing method according to an embodiment of the present disclosure.

According to an embodiment, in S210, a processor (e.g., the processor 110 of FIG. 1) may obtain target information of an image frame by applying the image frame to a first generation model trained to process an image based on a large language model (LLM).

The image frame refers to a single still image extracted from video data or individual image data obtained by capturing a specific moment. The processor may obtain image frames by splitting video data collected from a vehicle's black box, a user terminal's camera, or other image processing apparatus at uniform time intervals. Afterward, the image frame is entered into the first generation model trained based on the LLM to extract the target information.

The first generation model refers to a generation model trained to extract semantic information from an image by analyzing image data. The first generation model may precisely analyze a feature of a specific image by utilizing the few-shot learning technique. The first generation model receives an image frame and outputs target information. If the target information is not extracted from a specific image frame, the first generation model may output additional target information by utilizing subsequent frames.

The target information refers to a main keyword or feature information analyzed in the image frame. The target information may include a first keyword being location information where the image frame was captured, a second keyword being weather information at a location and a time point at which the image frame is captured, and a third keyword being mood information analyzed from the image frame. The processor may generate a recommended sentence by inputting the target information into a sentence generation model (e.g., a second generation model), and may recommend appropriate content, such as music, through a content recommendation model (e.g., a third generation model).

In S220, the processor may obtain at least one recommended sentence regarding content generation related to the image frame by applying the target information to a second generation model for sentence generation.

The second generation model refers to a model that generates sentences through natural language processing based on the target information. In the present disclosure, the second generation model includes a natural language processing model and plays a role in converting the target information extracted from the image frame into meaningful sentences. That is, the second generation model receives the target information (e.g., a location, weather, a mood, or the like), which is a keyword extracted by the first generation model, and generates a recommended sentence including the target information. For example, the processor may generate a sentence such as “recommendation music which is good to listen to at a beach in sunny weather”, by applying the target information, such as “a sunny weather image taken at the beach,” to the second generation model.

At least one recommended sentence refers to a sentence generated by the second generation model based on the target information and means a sentence subsequently used as input for content recommendations. The target information is extracted from the image frame in the first generation model; the recommended sentence is obtained by using the target information in the second generation model; and then, the recommended sentence is applied to the third generation model. Accordingly, the recommended sentence may be used to recommend the final content. At least one recommended sentence may be sorted depending on a user's priority, and the recommendation ranking may be updated if the user's response is reflected.

For example, if identifying an image frame taken by the user at a beach, the processor may obtain, from the image frame, a plurality of recommended sentences such as “recommend summer songs which is good to listen to at the beach” and “soft music to enjoy with a gentle breeze.”

In S230, the processor may obtain recommendation information of content by applying the target sentence among at least one recommended sentence to the third generation model trained to recommend content based on LLM.

The third generation model refers to a generation model that recommends appropriate content based on the target sentence among at least one recommended sentence. In the present disclosure, a model trained to recommend content based on LLM is used. The third generation model may be a model that receives the target sentence among at least one recommended sentence generated by the second generation model and then recommends highly relevant content with reference to the user's existing content list.

The recommendation information of content refers to information about the content (e.g., songs) recommended by the third generation model. In the present disclosure, the recommended content information is provided based on the user's response. The recommendation information of content may include identification information (e.g., a song title or an artist name) of the recommended content, type (e.g., a pop song, ballad, jazz, or the like) of the recommended content, and a recommendation priority (e.g., sorting ranking obtained by reflecting user preference).

The processor may train the first generation model, the second generation model, and the third generation model (hereinafter referred to as a “model”). For example, the model may include a neural network. The neural network may include a plurality of layers, and each layer may include a plurality of nodes. The node may include a node value determined based on an activation function. A node on any layer may be connected to a node (e.g., another node) on another layer through a link (e.g., a connection edge) with a connection weight. The node value of a node may be propagated to other nodes through the link. In an inference operation of the neural network, node values may be forward propagated from the previous layer to the next layer.

For example, the forward propagation operation in the model may indicate an operation of propagating node values based on input data in a direction from an input layer of the model to an output layer. In other words, the node value of the corresponding node may be propagated (e.g., forward propagated) to a node (e.g., the next node) of the next layer connected through the node and the connection edge. For example, the node may receive a value weighted by a connection weight from the previous node (e.g., a plurality of nodes) connected through the connection edge.

The node value of a node may be determined based on applying an activation function to the sum (e.g., weighted sum) of weighted values received from previous nodes. For example, a parameter of a neural network may include the connection weight described above. The parameters of the neural network may be updated such that a value of an objective function value described later changes in a targeted direction (e.g., a direction in which a loss is minimized).

The machine learning model (e.g., the trained model) may be created through machine learning. For example, the learning algorithm may include supervised learning, unsupervised learning, semi-supervised learning, or reinforcement learning, but is not limited to the above example.

The machine learning model may include a plurality of artificial neural network layers. The artificial neural network may be one of a deep neural network (DNN), a convolutional neural network (CNN), a U-Net for image segmentation (U-net), a recurrent neural network (RNN), a restricted Boltzmann machine (RBM), a deep belief network (DBN), a bidirectional recurrent deep neural network (BRDNN), or a deep Q-network, or at least one combination among combinations thereof, but may not be limited to the above-described example.

The first generation model may include an LLM trained with few-shot learning. The second generation model may include a natural language processing model. The third generation model may include an LLM trained to recommend content based on the user's existing content list.

In the case of supervised learning, the above-described machine learning model may be trained based on training data, including pairs of a training input and a training output mapped to the training input. For example, the machine learning model may be trained to output the training output from the training input. The machine learning model during training may generate a temporary output in response to the training input, and may be trained such that the loss between the temporary output and the training output (e.g., a training target) is minimized. During training, a parameter (e.g., a connection weight between nodes/layers in a neural network) of the machine learning model may be updated depending on the loss. For example, this training may be performed by the content processing apparatus where the machine learning model is performed or through a separate server. The machine learning model (e.g., the trained model) in which training is completed may be stored in a memory (e.g., the memory 120 in FIG. 1).

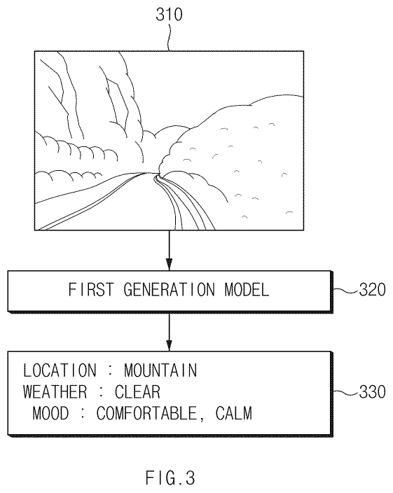

FIG. 3 is a diagram illustrating a method for obtaining target information through a first generation model in a content processing apparatus, according to an embodiment of the present disclosure.

A processor (e.g., the processor 110 of FIG. 1), according to an embodiment, may obtain target information 330 of an image frame 310 by applying the image frame 310 to a first generation model 320.

The processor may identify video data from an image processor included in a vehicle or a user's terminal. The processor may obtain the image frame 310 by splitting the video data based on a predetermined time.

In a case where the processor fails to obtain the target information 330 by applying the image frame 310 to the first generation model 320, the processor may obtain the target information 330 by applying a frame (or a frame preceding the image frame 310) subsequent to the image frame 310 in the video data to the first generation model 320.

If the processor fails to obtain the target information 330 from the first generation model 320 during a predetermined time interval, the processor may receive the target information 330 from an external server (e.g., the server 140 of FIG. 1).

The processor may extract the precise target information 330 by utilizing a plurality of consecutive image frames, not just analyzing the image frame 310. For example, if a vehicle is driving through a tunnel and then is driving on a mountain road, the processor may generate the sophisticated target information 330, such as “location: mountain, including tunnel,” by applying successive image frames to the first generation model 320.

The processor may emphasize or filter specific target information depending on the user's preferences. For example, if the first generation model 320 identifies the mood of “comfortable, calm” when a user “prefers music with a lively mood,” the processor may generate the modified target information 330 of “liveness in nature” through further analysis.

The processor may generate the target information 330 in conjunction with road conditions, traffic volume, event information, or the like. For example, the processor may variously generate the target information 330 through the first generation model 320 depending on whether a road on which the user is driving is a “quiet mountain road” or a “road to a famous tourist destination.”

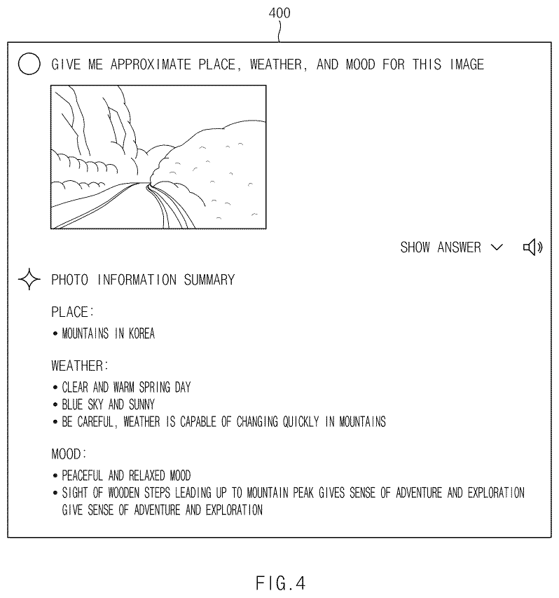

FIG. 4 is a drawing illustrating an example of an interface for outputting target information in a content processing apparatus, according to an embodiment of the present disclosure.

A processor (e.g., the processor 110 of FIG. 1), according to an embodiment, may output an interface 400 that provides a user with target information (e.g., the target information 330 of FIG. 3) obtained by applying an image frame (e.g., the image frame 310 of FIG. 3) to a first generation model (e.g., the first generation model 320 of FIG. 3).

The processor may analyze the place, weather, and mood of the image frame by using the first generation model and may convert the corresponding information into a text format. The processor may display the obtained target information in the form of a “photo information summary” on the interface 400. Place information (i.e., a first keyword) may be provided as “mountains in Korea.” Weather information (i.e., a second keyword) may include detailed weather conditions, such as “clear and warm spring day” or “blue sky and sunny.” Mood information (i.e., a third keyword) may include emotional elements, such as “peaceful and relaxed mood,” and “feels like exploration, while lush greenery and a blue sky create a sense of freshness.”

The processor may provide additional information at the user's request or may perform a function of reading the content by activating a voice output function. The processor may allow the user to easily understand intuitive analysis results for images through the interface 400.

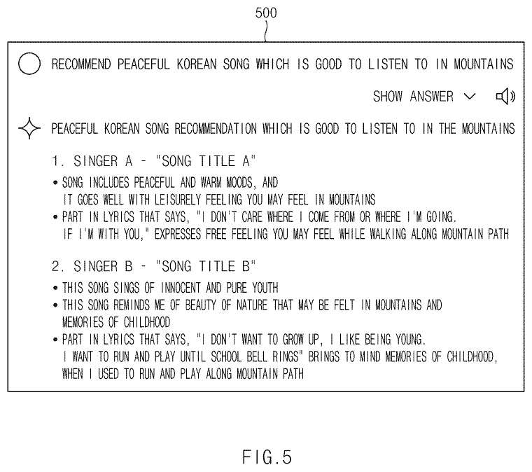

FIG. 5 is a diagram illustrating an example of an interface for outputting recommendation information of content in a content processing apparatus, according to an embodiment of the present disclosure.

A processor (e.g., the processor 110 of FIG. 1), according to an embodiment, may obtain at least one recommended sentence including a first keyword, a second keyword, and a third keyword by applying the first keyword, the second keyword, and the third keyword to a second generation model.

The processor may sort at least one recommended sentence depending on a first priority based on the predetermined first priority. If a predetermined second priority of the user is identified, the processor may sort the sorted at least one recommended sentence depending on the second priority. The processor may determine a sentence with the highest priority among the sorted at least one recommended sentence as a target sentence.

For example, the processor may obtain at least one recommended sentence by applying the first keyword (e.g., place-mountain), the second keyword (e.g., weather-clear), and the third keyword (e.g., mood-peaceful) to the second generation model. Here, at least one of the recommended sentences may include, “recommend a peaceful song which is good to listen to in the mountains.”, “recommend a peaceful song which is good to listen to in clear weather.”, and “recommend a song which is good to listen to in the mountains on a clear day.”

For example, the processor may sort at least one recommended sentence depending on the first priority. Here, the first priority may include any priority. If the second priority is identified, the processor may sort sentences of “recommend a peaceful song which is good to listen to in mountains.”, “recommend a peaceful song which is good to listen to in clear weather.”, and “recommend a song which is good to listen to in the mountains on a clear day.”, which are included in at least one recommendation sentence in the order of “recommend a peaceful song which is good to listen to in mountains.”, “recommend a song which is good to listen to in the mountains on a clear day.”, and “recommend a peaceful song which is good to listen to in clear weather.”

For example, the processor may determine the sentence “recommend a peaceful song which is good to listen to in mountains.” as the target sentence from the sorted at least one recommendation sentences: “recommend a peaceful song which is good to listen to in the mountains.”, “recommend a song which is good to listen to in the mountains on a clear day.”, and “recommend a peaceful song which is good to listen to in clear weather.”.

The processor may obtain recommendation information about content by applying the target sentence (e.g., “recommend a peaceful song which is good to listen to in mountains.”) to the third generation model. The third generation model may recommend user-customized content based on LLM. For example, the processor may generate recommendation information such as “Singer A-Song Title A” and “Singer B-Song Title B.”

The processor may output recommendation information of the content to an interface 500. For example, together with a title of “recommend peaceful Korean songs which are good to listen to in the mountains,” titles and descriptions of the recommended songs may be displayed in the interface 500. The processor may provide a description of each recommended song, including the song's mood, lyrical features, and emotional elements. The processor may receive the user's response and may play specific content if the user selects the corresponding content.

For example, if the user selects “Singer A-Song Title A,” the corresponding song may be played automatically. The processor may update the recommendation priorities based on the user's response, allowing for more sophisticated content recommendations in the future. For example, if the user consistently selects a specific style of music, the processor may assign a higher priority to that style in future recommendations.

The processor may provide a function that outputs recommended content information via voice. For example, if the user activates a voice support option, the processor may automatically read the recommended song list and descriptions. The processor may continuously optimize a content recommending method by reflecting the user's feedback. For example, if the user selects a specific song as “likes”, this may increase the probability that similar songs are to be recommended in the future.

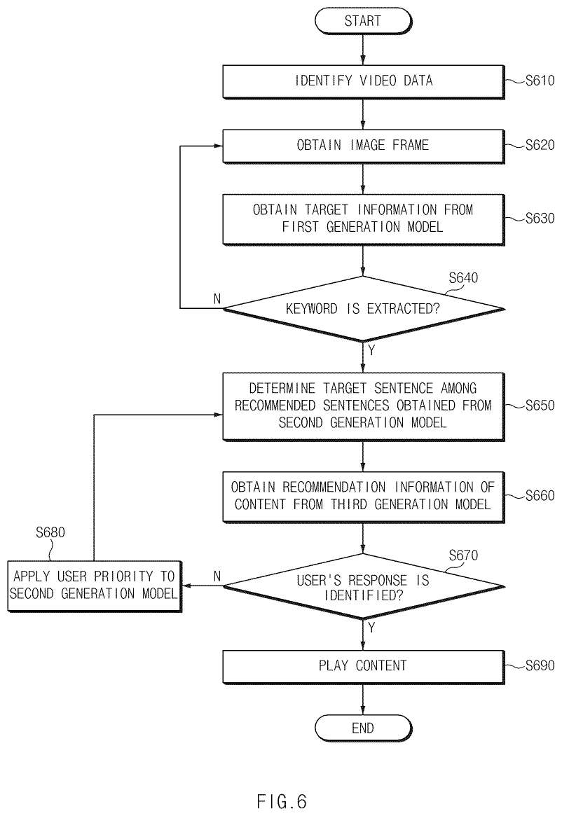

FIG. 6 is a flowchart for describing a content processing method in a content processing apparatus, according to an embodiment of the present disclosure.

In S610, a processor (e.g., the processor 110 of FIG. 1), according to an embodiment, may identify video data. The processor may receive video data from a vehicle's black box, a smartphone camera, or other image processing apparatuses. For example, the processor may analyze in real time an image captured by a black box while a vehicle is in motion or may determine a video captured by a user as the video data to be analyzed. The processor may identify data required for analysis by identifying metadata (shooting time, location, resolution, or the like) of the video data.

In S620, the processor may obtain an image frame from the video data. The processor may obtain static image frames by splitting the video data into predetermined time intervals. For example, the processor may extract one image frame every second and may perform detailed analysis based on frames per second (fps). The processor may selectively extract main scenes as frames based on specific conditions (e.g., rapid change in illumination, color changes, or the like).

In S630, the processor may obtain target information from a first generation model. The processor may derive information, such as a location, weather, and mood, by analyzing an object, background, color, texture, or the like within an image frame.

In S640, the processor may determine whether a keyword (i.e., the target information) is extracted. If the target information (e.g., a place, weather, or a mood) is not extracted normally, the processor may obtain supplemented target information by analyzing subsequent or preceding frames of the video data.

If the target information acquisition fails during a specific time, the processor may perform additional analysis by sending a request to an external server (e.g., the server 140 in FIG. 1).

In the S650, the processor may determine a target sentence among recommended sentences obtained from a second generation model. For example, the processor may generate recommendation sentences such as “recommend a peaceful song which is good to listen to in the mountains.”, “recommend a peaceful song which is good to listen to in clear weather.”, and recommend a song which is good to listen to in the mountains on a clear day.”. The processor may sort at least one recommended sentence based on a predetermined first priority and determine the sentence with the highest priority among the recommended sentences as the target sentence. If the user's preference data is reflected, the processor may also adjust the sort order of at least one recommended sentence by applying a second priority.

In S660, the processor may obtain recommendation information of content from a third generation model. The third generation model may recommend optimal content with reference to LLM and the user's previous listening history. For example, the processor may generate content recommendation information such as “emotional ballad A,” “gentle piano music B,” or the like. The processor may also generate a list of playable content by operating in conjunction with a streaming service (e.g., a music platform) capable of providing recommended content information.

In S670, the processor may identify the user's response. If the content is a song, the processor may identify at least one song title from the recommendation information. The processor may receive the user's response by providing the user with at least one song title. In S690, the processor may play a song regarding one song title among at least one song title based on the user's response.

The processor may provide the user with a list of recommended song titles and may recognize the user's selection as a response if the user selects a specific song. The user's response may include a variety of input forms, such as touch, voice commands, or button selection. For example, if the user selects “emotional ballad A,” the processor may be configured to play the corresponding song.

In S680, the processor may assign a user priority to a second generation model. For example, the processor may update the second priority based on the user's response. The processor may perform re-learning of the second generation model based on the updated second priority.

For example, if a user consistently selects a specific style of music, the processor may train a model to give greater priority to that specific style of music when generating future recommendation sentences. The processor may update the second priority by reflecting the user's preference and may perform the retraining of the second generation model based on the updated second priority. If the user repeatedly selects “gentle classical music”, the processor may recommend classical music with a higher priority in similar environments.

In S690, the processor may play the final selected content based on the user's response. For example, if the user selects “emotional ballad A,” the processor may play the corresponding song in conjunction with a music streaming service. The processor may store the playback history of content to reflect the playback history of content in future recommendation systems. If the user enters an additional command (e.g., playing the next song, adjusting volume, or the like) while the content is played, the processor may process the corresponding request.

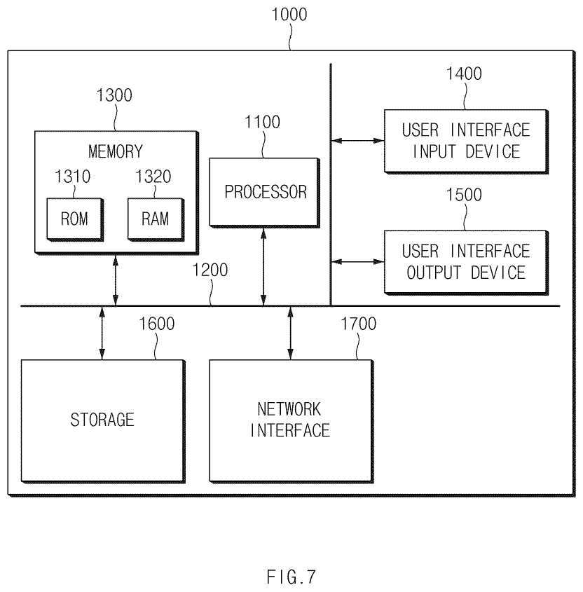

FIG. 7 is a diagram illustrating a computing system related to a content processing apparatus or a content processing method, according to an embodiment of the present disclosure.

Referring to FIG. 7, a computing system 1000 related to a content processing apparatus or a content processing method may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented using a hardware module, a software module, or a combination of both, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and variations may be made by one skilled in the art without departing from the essential characteristic of the present disclosure.

The above-described embodiments may be implemented with hardware elements, software elements, and/or a combination of hardware elements and software elements. For example, the devices, methods, and components described in embodiments of the present disclosure may be implemented by using general-use computers or special-purpose computers, such as a processor, a controller, an arithmetic logic unit (ALU), a digital signal processor, a microcomputer, a field programmable array (FPA), a programmable logic unit (PLU), a microprocessor, or any device which may execute instructions and respond. A processing device may perform an operating system (OS) or a software application running on the OS. Further, the processing device may access, store, manipulate, process, and generate data in response to the execution of software. It will be understood by those skilled in the art that although a single processing device may be illustrated for convenience of understanding, the processing device may include a plurality of processing elements and/or a plurality of types of processing elements. For example, the processing device may include a plurality of processors or one processor and one controller. Also, the processing device may include a different processing configuration, such as a parallel processor.

Software may include computer programs, codes, instructions or one or more combinations thereof and configure a processing device to operate in a desired manner or independently or collectively control the processing device. Software and/or data may be permanently or temporarily embodied in any type of machine, components, physical equipment, virtual equipment, computer storage media or units or transmitted signal waves so as to be interpreted by the processing device or to provide instructions or data to the processing device. Software may be dispersed throughout computer systems connected over networks and be stored or executed in a dispersion manner. Software and data may be recorded in a computer-readable storage medium.

The methods according to the above-described embodiments may be recorded in a computer-readable medium including program instructions that are executable through various computer devices. The computer-readable medium may also include program instructions, data files, data structures, and the like, singly or in combination. The program instructions recorded in the medium may be designed and configured specially for the embodiments of the present disclosure or may be known and available to those skilled in computer software. The computer-readable medium may include hardware devices, which are specially configured to store and execute program instructions, such as magnetic media (e.g., a hard disk, a floppy disk, or a magnetic tape), optical recording media (e.g., CD-ROM and DVD), magneto-optical media (e.g., a floptical disk), read only memories (ROMs), random access memories (RAMs), and flash memories. Examples of computer programs include not only machine language codes created by a compiler, but also high-level language codes that are capable of being executed by a computer by using an interpreter or the like.

The hardware device described above may be configured to act as one or more software modules to perform the operations of the above-described embodiments of the present disclosure, or vice versa.

Even though the embodiments are described with reference to restricted drawings, it may be obvious to one skilled in the art that the embodiments are variously changed or modified based on the above description. For example, adequate effects may be achieved even though the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

Accordingly, embodiments of the present disclosure are intended not to limit but to explain the technical idea of the present disclosure, and the scope and spirit of the present disclosure are not limited by the above embodiments. The scope of protection of the present disclosure should be construed by the attached claims, and all equivalents thereof should be construed as being included within the scope of the present disclosure.

Descriptions of a content processing apparatus according to an embodiment of the present disclosure, and a method therefor are as follows.

According to at least one of the embodiments of the present disclosure, it is possible to provide appropriate music to a user even though he/she is driving or his/her hand is not free by analyzing the user's environment in real time in conjunction with a black box camera, a smartphone camera, and other image sensors, and providing a more intuitive and convenient music recommendation experience.

Moreover, according to at least one of the embodiments of the present disclosure, it is possible to automatically select music suitable for driving environments (e.g., night driving, rainy days, highway driving, etc.) by analyzing a black box video.

Moreover, according to at least one of the embodiments of the present disclosure, it is possible to provide various songs by training the user's music listening pattern such that the same music is not recommended every time.

Besides, a variety of effects directly or indirectly understood through the present disclosure may be provided.

Hereinabove, although the present disclosure was described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. A content processing apparatus comprising:
a memory configured to store computer-executable instructions; and
a processor configured to access the memory and execute the instructions,
wherein the instructions comprise:
obtaining target information of an image frame by applying the image frame to a first generation model trained to process an image based on a large language model (LLM);
obtaining at least one recommended sentence regarding generating content related to the image frame by applying the target information to a second generation model for sentence generation;
obtaining recommendation information for content by applying a target sentence among the at least one recommended sentence to a third generation model trained to recommend the content based on the LLM; and
providing the recommendation information based on a response of a user for identifying the content.

2. The content processing apparatus of claim 1, wherein the instructions further comprise:
identifying video data from an image processor included in a vehicle or a terminal of the user;
obtaining the image frame by splitting the video data based on a predetermined time; and
obtaining the target information by applying a frame subsequent to the image frame in the video data to the first generation model when failing to obtain the target information by applying the image frame to the first generation model.

3. The content processing apparatus of claim 2, wherein the instructions further comprise
receiving the target information from an external server when failing to obtain the target information from the first generation model during a predetermined time interval.

4. The content processing apparatus of claim 1, wherein the first generation model includes an LLM trained with few-shot learning;
wherein the second generation model includes a natural language processing model;
wherein the third generation model includes an LLM trained to recommend content based on an existing content list of the user; and
wherein the target information includes one or more keywords or a combination of multiple keywords from a first keyword regarding a location where the image frame is captured, a second keyword regarding weather of the location and a time point at which the image frame is captured, or a third keyword regarding a mood of the image frame.

5. The content processing apparatus of claim 4, wherein the instructions further comprise:
obtaining the at least one recommended sentence, comprising the first keyword, the second keyword, and the third keyword, by applying the first keyword, the second keyword, and the third keyword to the second generation model.

6. The content processing apparatus of claim 1, wherein the instructions further comprise:
sorting the at least one recommended sentence depending on a first priority, based on the predetermined first priority;
sorting the sorted at least one recommended sentence depending on a second priority when the predetermined second priority of the user is identified; and
determining a sentence with the highest priority among the sorted at least one recommended sentence as the target sentence.

7. The content processing apparatus of claim 6, wherein the instructions further comprise:
identifying at least one song title from the recommendation information if the content is a song;
receiving a response from the user by providing the user with the at least one song title; and
playing a song having one song title among the at least one song title based on the response of the user.

8. The content processing apparatus of claim 7, wherein the instructions further comprise:
updating the second priority based on the response of the user.

9. The content processing apparatus of claim 1, wherein the target information includes a location, weather, or a mood.

10. A content processing method, the method comprising:
obtaining the target information of an image frame by applying the image frame to a first generation model trained to process an image based on an LLM;
obtaining the at least one recommended sentence regarding generating content related to the image frame by applying the target information to a second generation model for sentence generation;
obtaining recommendation information of content by applying the target sentence among the at least one recommended sentence to a third generation model trained to recommend the content based on the LLM; and
providing the recommendation information based on a user's response to identify the content.

11. The method of claim 10, wherein the providing of the recommendation information includes:
identifying video data from the image processor included in a vehicle or a terminal of the user;
obtaining the image frame by splitting the video data based on a predetermined time; and
obtaining the target information by applying a frame subsequent to the image frame in the video data to the first generation model when failing to obtain the target information by applying the image frame to the first generation model.

12. The method of claim 11, wherein the providing of the recommendation information includes:
receiving the target information from an external server when failing to obtain the target information from the first generation model during a predetermined time interval.

13. The method of claim 10, wherein the first generation model includes an LLM trained with few-shot learning;
wherein the second generation model includes a natural language processing model;
wherein the third generation model includes an LLM trained to recommend content based on an existing content list of the user; and
wherein the target information includes at least one of a first keyword regarding a location where the image frame is captured, a second keyword regarding weather of the location and a time point at which the image frame is captured, or a third keyword regarding a mood of the image frame, or any combination thereof.

14. The method of claim 13, wherein the providing of the recommendation information includes:
obtaining the at least one recommended sentence comprising the first keyword, the second keyword, and the third keyword by applying the first keyword, the second keyword, and the third keyword to the second generation model.

15. The method of claim 10, wherein the providing of the recommendation information includes:
sorting the at least one recommended sentence depending on the first priority, based on the predetermined first priority;
sorting the sorted at least one recommended sentence depending on a second priority when the predetermined second priority of the user is identified; and
determining a sentence with the highest priority among the sorted at least one recommended sentence as the target sentence.

16. The method of claim 15, wherein the providing of the recommendation information includes:
identifying at least one song title from the recommendation information when the content is a song;
receiving a response from the user by providing the user with the at least one song title; and
playing a song having one song title among the at least one song title based on the response of the user.

17. The method of claim 10, wherein the providing of the recommendation information includes:
updating the second priority based on the response of the user.

18. The method of claim 10, wherein the target information includes a location, weather, or a mood.
